(19) United States
(12) Patent Application Publication
(10) Pub. No.: US 2005/0289209 A1
(43) Pub. Date: Dec. 29, 2005

(54) Method and system of achieving integer division by invariant divisor using N-bit multiply-add operation

(75) Inventor: Arch D. Robison, Champaign, IL (US)

Correspondence Address: Lawrence Cho Attorney at Law;C/O PortfolioIP, P.O. Box 52050, Minneapolis, MN, 55402, US

(73) Assignee: Intel Corporation

(21) Appl. No.: 10/879,397

(22) Filed: Jun. 29, 2004

(51) Int. Cl. G06F 7/52

(52) U.S. Cl. 708/650

(57) ABSTRACT

An integer division system for a dividend and a divisor includes a pre-calculation module to select a reciprocal approximation and a rounding error compensation value of the divisor, and an instruction generation module to generate at least an instruction to calculate a quotient of the dividend using the reciprocal and the rounding error compensation value. The reciprocal approximation is of the same predetermined number of binary bits as the divisor and the pre-calculation module determines which one of rounding-up and rounding-down is used when selecting the reciprocal approximation and the rounding error compensation value.

### TECHNICAL FIELD

Embodiments of the present invention pertain to compilation and execution of software programs. More specifically, embodiments of the present invention relate to a method and system of achieving integer division by an invariant divisor (e.g., compile-time constant or run-time invariant) using an N-bit multiply-add operation with minimized rounding error in the reciprocal approximation of the divisor.

### BACKGROUND

Integer division on processors is typically more expensive than multiplication. Typically, integer division is relatively infrequent compared to other arithmetic operations. Because of this and because of the complexity of directly implementing division in hardware within a processor, there has been a consequent trend in modern processor architectures to omit direct hardware support for integer division, and instead to rely on software implementation.

A case of particular interest for implementing integer division in software is when the divisor is a compile-time constant, or a run-time loop-invariant. Prior research and development has shown that in such situations, the unsigned integer division x/d can be computed as (ax+b)/2^{s}, wherein a is a scaled reciprocal approximation of the divisor, b compensates for rounding error, and s is a right-shift count. By using a reciprocal approximation, integer division can be implemented as a multiply-add operation, followed by a right-shift operation.

In this case, the reciprocal of the divisor must be carefully selected or determined. Without carefully selecting the reciprocal approximation, the quotient obtained often suffers from off-by-one errors. To determine the value of the reciprocal, the approximation a can be rounded up or rounded down from the exact scaled reciprocal. However, for performing N-bit division, all prior implementations based on the formula (ax+b)/2^{s} require, in the worst case, that the approximation a be rounded to N+1 bits of significance. The extra bit beyond N bits makes the multiply-add operation an N+1 bit multiply-add operation.

The prior implementations suffer from the requirement for N+1 bit multiplication. This is due to the fact that processors naturally implement only N-bit arithmetic. Consequently, the N+1 bit multiplication must be synthesized from N-bit multiplication and additional arithmetic operations, adding extra processing operations for the integer division. For some divisors (e.g., the reciprocal approximation ends in a “0”), the extra bit can be optimized away because it is zero, or for even divisors, the dividend can be pre-shifted by a bit to reduce the problem to dividing by an N−1 bit divisor. But this is not always possible, particular for loop-invariant divisors, where the code within the loop body must handle the worst case where the divisor is odd, and the reciprocal approximation ends in a “1”.

Thus, there exists a need for a method and system of achieving integer division by an invariant divisor (e.g., compile-time constant or run-time invariant) using an N-bit multiply-add operation with minimized rounding error in the reciprocal approximation of the divisor.

### BRIEF DESCRIPTION OF THE DRAWINGS

The features and advantages of embodiments of the present invention are illustrated by way of example and are not intended to limit the scope of the embodiments of the present invention to the particular embodiments shown.

FIG. 1 shows the structure of an integer division system that implements an embodiment of the present invention, wherein the integer division system includes a pre-calculation module and an instruction generation module.

FIG. 2 shows a compiler implementation of the integer division system of FIG. 1 in accordance with an embodiment of the present invention.

FIG. 3 shows a runtime environment that includes a just-in-time compiler that includes the integer division system of FIG. 1 in accordance with another embodiment of the present invention.

FIG. 4 is a flowchart diagram showing, in general, the pre-calculation process performed by the pre-calculation module of FIG. 1 to calculate the reciprocal approximation of the divisor and the rounding error compensation value.

FIG. 5 is a flowchart diagram showing one specific pre-calculation process of the pre-calculation module of FIG. 1, wherein the process is for N-bit unsigned division and employs integer arithmetic.

FIG. 6 is a flowchart diagram showing another specific pre-calculation process of the pre-calculation module of FIG. 1, wherein the process is for N-bit signed division over unsigned divisor and employs integer arithmetic.

FIG. 7 is a flowchart diagram showing yet another specific pre-calculation process of the pre-calculation module of FIG. 1, wherein the process is for N-bit unsigned division and employs floating-point arithmetic.

FIG. 8 is a flowchart diagram showing a still another specific pre-calculation process of the pre-calculation module of FIG. 1, wherein the process is for N-bit signed division over unsigned divisor and employs floating-point arithmetic.

### DETAILED DESCRIPTION

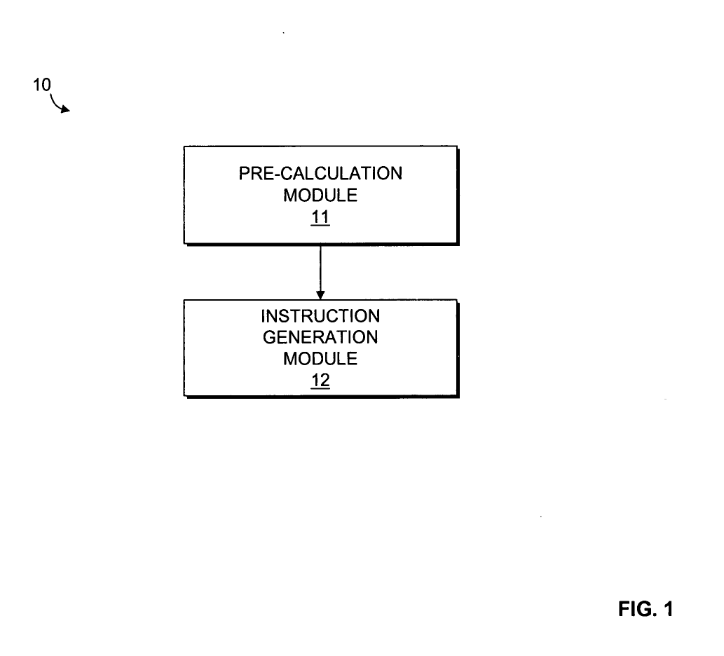

FIG. 1 shows an integer division system 10 that achieves integer division by a constant or invariant divisor (e.g., compile-time constant or run-time invariant) d using an N-bit multiply-add operation with minimized rounding error in the reciprocal approximation of the divisor. In accordance with an embodiment of the present invention, the integer division system 10 examines the divisor d to determine whether to round its reciprocal up or down to N bits. This allows the integer division system 10 to avoid extra operations to synthesize the N+1 bit arithmetic, thus reducing the division to the N bits (upper or lower) of a multiply-add operation, followed by a right-shift operation.

As can be seen from FIG. 1, the integer division system 10 includes a pre-calculation module 11 and an instruction generation module 12. The pre-calculation module 11 is used to select the reciprocal approximation a of the divisor d and a rounding error compensation value b for the reciprocal approximation a. The instruction generation module 12 is used to generate a multiply-add instruction and shift-right instruction to calculate a quotient of the division using the reciprocal approximation a, the rounding error compensation value b, and shift count m.

As will be described in more detail below and in accordance with an embodiment of the present invention, the pre-calculation module 11 determines whether rounding-up or rounding-down should be used to select the reciprocal approximation a and/or the rounding error compensation value b. The pre-calculation module 11 also computes a shift count m. The pre-calculation module 11 either uses integer arithmetic or floating-point arithmetic to compute the determination. Here, the terms rounding-up and rounding-down refer to rounding the reciprocal approximation a up or down to N bits from N+1 bits and determining the rounding error compensation value b. For example, the rounding-up can mean that the reciprocal approximation a is set to be the leading N-bits of 1/d plus 1 while the rounding-down can indicate that the reciprocal approximation a is set to be the leading N-bits of 1/d. For signed division over unsigned divisor, the rounding-up and rounding-down can mean rounding towards positive and negative infinity, respectively. Here, leading N-bits means the N most significant bits starting with the leftmost 1.

The test used to make the rounding determination depends on whether the integer division is signed or unsigned and whether integer arithmetic or floating-point arithmetic is used to make the rounding-up and rounding-down determination. Using integer arithmetic for unsigned integer division, the pre-calculation module 11 determines whether to round the reciprocal approximation a up or down using the following test:
(td+d) mod 2^{N}≦2^{m}
wherein t=floor((2^{m+N})/d) and m=floor(log₂(d)). The value m indicates the amount of non-implicit right-shift count. The notation floor (x) denotes the greatest integer that does not exceed x. Here, the test applies unless the divisor d is equal to 2^{m} (i.e., the divisor is a power of 2). If the test is true, the pre-calculation module 11 rounds the reciprocal approximation a up (i.e., a=t+1), and the rounding error compensation value b is set to zero. If the test is false, the pre-calculation module 11 rounds the reciprocal approximation a down (i.e., a=t), and the rounding error compensation value b can be selected to be a.

Using the integer arithmetic and for signed integer division over unsigned divisor, the pre-calculation module 11 determines whether to round the reciprocal approximation a up (i.e., towards positive infinity) or down (i.e., towards negative infinity) using the following test:
(td+d) mod 2^{N}≦XMA.HU(d, t, 0)
wherein t=floor((2^{m+N})/d) and m=floor(log₂(d)), and XMA.HU (d, t, 0) denotes a fused multiply-add operation that delivers the high N-bits of dt+0. Here, the test applies unless the divisor d is equal to 2^{m}. If the test is true, the pre-calculation module 11 rounds the reciprocal approximation a up (i.e., a=t+1). If the test is not true, the pre-calculation module 11 rounds the reciprocal approximation a down (i.e., a=t). The rounding error compensation value b can be selected to be t/2 for both the rounding-up and rounding-down cases.

Using the floating-point arithmetic, the pre-calculation module 11 calculates the reciprocal approximation a using the following formula:
a=SIGNIFICAND (t)
wherein t=RND_{N}(1/d). Here, RND_{N} means to round the value 1/d to the nearest N significant bits (unless d=2^{N}−1). If d=2^{N}−1, it is acceptable to either round to the nearest N significant bits, or to round down to 2^{-N}. SIGNIFICAND(x) means the N most significant bits of the floating-point representation of x.

As for the rounding error compensation value b, the pre-calculation module 11 needs to determine whether the rounding-up or rounding-down should be used to calculate the value. For unsigned integer division using the floating-point arithmetic, the pre-calculation module 11 employs the following test for the determination:
RND_{N}(−dt+1)≦0
wherein m=(BIAS−1)−EXPONENT (t). The RND_{N} is a reminder that the calculation should be done as a fused negative-multiply-add with only a final rounding and no intermediate rounding. BIAS denotes the bias typical in floating-point representations, and EXPONENT denotes the biased floating-point exponent (i.e., a value x is represented in floating-point as SIGNIFICAND(x)*2^{(EXPONENT(x)-BIAS-N+1)}). If the test is true, the pre-calculation module 11 selects the rounding error compensation value b to be equal to 0 (because the test indicates that rounding up occurred). Otherwise, the value b can be set at a (because the test indicates that rounding down occurred). For signed division over unsigned divisor, the rounding error compensation value b can be simply set at t/2 for both rounding-up and rounding-down (i.e., no need to make the determination). The integer division system 10 will be described in more detail below, also in conjunction with FIGS. 1-8.

Referring again to FIG. 1, the integer division system 10 can be implemented by software or firmware. For calculation using integer arithmetic, the hardware architectural support of the integer division system 10 includes a processor that supports an N-bit integer fused multiply-add instruction denoted XMA.HU. The execution of that instruction delivers or returns the upper (or high) N-bits of the calculation (ax+b). Alternatively, an integer fused multiply-add instruction denoted XMA.LU could be used to deliver or return the lower N-bits of the calculation (ax+b).

Here, the term fused means that the multiply and add arithmetic operations are done as a single operation that internally computes with 2N bits of precision, but delivers only the upper (or lower) N bits. For a, x, and b that are N-bit unsigned integers, the above instructions can be defined more formally as:
XMA.HU (a, x, b)=(ax+b)/2^{N}
XMA.LU (a, x, b)=(ax+b) mod 2^{N}.

In an embodiment, the N-bit processor is a 64-bit processor. Alternatively, the processor can be of different length. For example, the N-bit processor can be a 32-bit processor or a 128-bit processor.

On processors that do not have the multiply-add instructions, the instruction XMA.LU can be simulated with an N-bit multiplication and N-bit addition while XMA.HU can be simulated by calculating ax+b exactly using, for example, 2N-bits and taking just the upper N-bits. The multiply-add instructions can also be simulated on processors that have a signed multiply-accumulate instruction. For example, XMA.HU (a, x, b) can be simulated as “x+(XMA.HS (a, x, b))”, wherein XMA.HS denotes a multiply-add instruction that treats a and x (but not b) as signed integers.

In addition to the integer fused multiply-add instruction, the hardware architectural support of the integer division system 10 also includes a shift-right instruction denoted SHR.U (x, m)=(x/2^{m}).

When using the floating-point arithmetic, the hardware architectural support of the integer division system 10 includes (1) an N-bit processor that supports a floating-point fused multiply-add instruction, and (2) an operation to extract the binary exponent and significand from the floating-point value. For example, for floating-point values u, v, and w, this operation is denoted as (uv+w)ₘ, which computes the (uv+w) with a single final rounding to N-bits of significance, wherein N includes the leading 1 bit. The exponent bias is denoted as BIAS, and the operations to extract the exponent and significand are respectively denoted as EXPONENT and SIGNIFICAND. A non-zero value f has the value SIGNIFCAND (f)*2^{EXPONENT(f)-BIAS-N+1}.

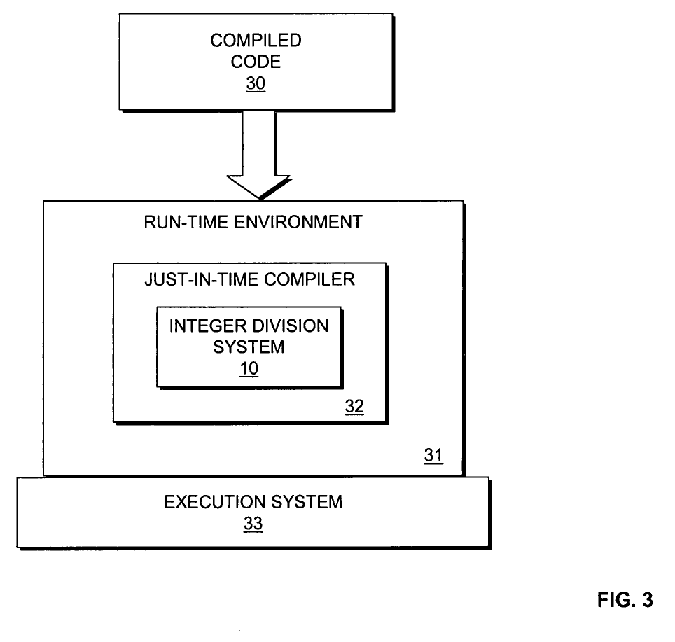

An integer arithmetic unit and a floating-point arithmetic unit of a processor or microprocessor (not shown in FIG. 1 but can be included in the execution system 33 of FIG. 3) may offer the above-described hardware support. The processor can be a processor within a computer system, which can be a personal computer system, a notebook computer system, a workstation computer system, a mainframe computer system, a server computer system, or a supercomputer. Alternatively, a lookup table can be pre-established in a cache of a processor for all the reciprocal approximation values and the corresponding rounding error compensation values. During operation, the processor can access the lookup table to retrieve the reciprocal approximation and rounding error compensation value of a particular divisor.

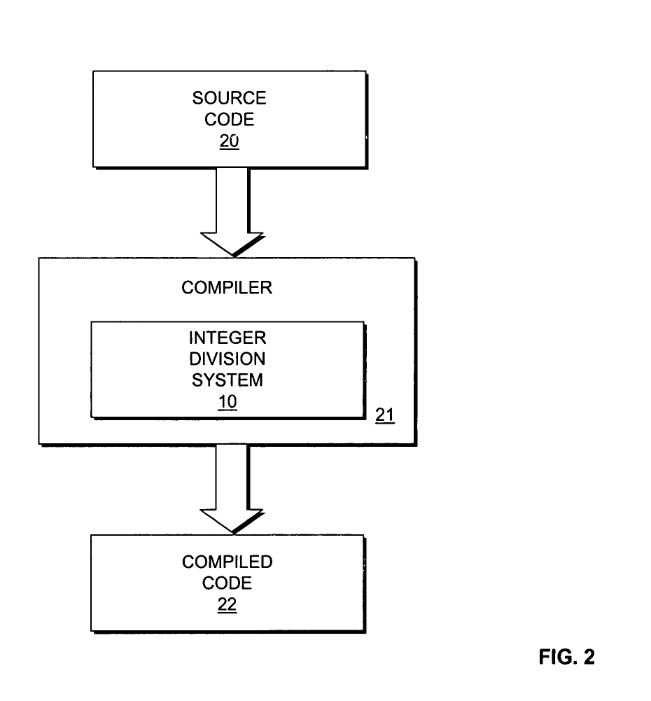

The integer division system 10 can be implemented in many different systems. For example, the integer division system 10 can be implemented in a compiler (e.g., FIG. 2). In another example, the integer division system 10 can be implemented in a just-in-time compiler of a runtime environment, as is shown in FIG. 3. In a further example, the integer division system 10 can be implemented as a firmware in a processor to do the on-the-fly integer division, including the calculation of the reciprocal approximation a and the rounding error compensation value b. In a further embodiment, the integer division system 10 can be implemented inside software programs (e.g., compiled codes). The compiler implementation and the just-in-time compiler implementation will be described in more detail below, also in conjunction with FIGS. 2-3.

According to an embodiment of the present invention, FIG. 2 shows the compiler implementation of the integer division system 10 of FIG. 1. As can be seen from FIG. 2, the compiler 21 is used for compiling a source code program 20 into a compiled code 22. The compiler 21 includes the integer division system 10 of FIG. 1. The source code 20 is a software program written in one of known high-level programming languages (e.g., C++). The compiled code 22 may be native code that can be directly executed on a platform-specific data processing system or a computer system. Alternatively, the compiled code 22 can also be an intermediate language code (e.g., Java byte-code) that may then be interpreted or subsequently compiled by a just-in-time (JIT) compiler within a runtime system (or virtual machine) into native or machine code that can be executed by a platform-specific target computer system. The compiler 21 is a software system hosted by (or run on) a computer system. During compilation, the compiler 21 calls for the integer division system 10 when the compiler 21 is compiling an integer division instruction with a known or constant divisor.

FIG. 3 shows a runtime environment implementation of the integer division system 10 of FIG. 1. As can be seen from FIG. 3, the runtime environment 31 compiles a compiled code 30 into native (or machine) code that is executed by an execution system 33. The runtime environment 31 is a software system (or a Java virtual machine) that operates on and is hosted by the execution system 33. The execution system 33 employs the runtime environment 31 to help further compile the compiled code 30 into native code that is platform-specific (or architecture-specific) to the execution system 33. The runtime environment 31 can also be referred to as a virtual machine or runtime system.

The execution system 33 can be, for example, a personal computer, a personal digital assistant, a network computer, a server computer, a notebook computer, a workstation, a mainframe computer, or a supercomputer. In an embodiment of the present invention, the execution system 33 includes a process (not shown) that includes a cache (also not shown) that includes a lookup table for all the reciprocal approximation values and the corresponding rounding error compensation values. The compiled code 30 may be delivered to the execution system 33 via a communication link such as a local area network, the Internet, or a wireless communication network.

The runtime environment 31 includes a just-in-time compiler 32 that employs the integer division system 10 of FIG. 1. The just-in-time compiler 32 compiles the compiled code 30 to generate native or machine code at runtime. The term “just-in-time” means that the just-in-time compiler 32 compiles or translates into native code each method or class within the compiled code 30 when it is actually used for execution. When the just-in-time compiler 32 encounters an integer division instruction, it calls for the integer division system 10.

Alternatively, the integer division system 10 can be implemented inside a compiled code (e.g., the compiled code 30 ). In this case, the integer division system 10 can be implemented as a code sequence within the program, and is executed before a loop with a loop-invariant divisor is entered. The integer division system 10 in this implementation can also be implemented as a code sequence within a program, and is executed for multiple divisions with the same divisor. In this case, the compiled code can be directly executed or further compiled by a JIT compiler that does not contain the integer division system 10.

Referring back to FIG. 1 and as described above, the integer division system 10 is used to realize an integer division using a multiply-add operation, plus a right-shift operation. When an integer division instruction with a known or constant divisor is received in the integer division system 10, the integer division system 10 returns the multiply-add instruction and the shift-right instruction that can carry out the integer division when the dividend becomes known. For example, for an integer division with a dividend x and a divisor d, the integer division system 10 converts the division into (ax+b)/2^{s}, wherein a is the reciprocal approximation of the divisor, b is the rounding error compensation value, and s is the right-shift count. The integer division system 10 then generates the multiply-add and shift-right instructions.

The integer division system 10 employs the instruction generation module 12 to generate the multiply-add and shift-right instructions. For example, with above described hardware support and for an unsigned integer division of x/d, the multiply-add and shift-right instruction generated by the instruction generation module 12 is SHR.U (XMA.HU (a, x, b), m). If the integer division is for a signed integer division over an unsigned integer divisor, then the multiply-add and shift-right instruction generated by the instruction generation module 12 is SHR.U (x+XMA.HS (a, x, b), m).

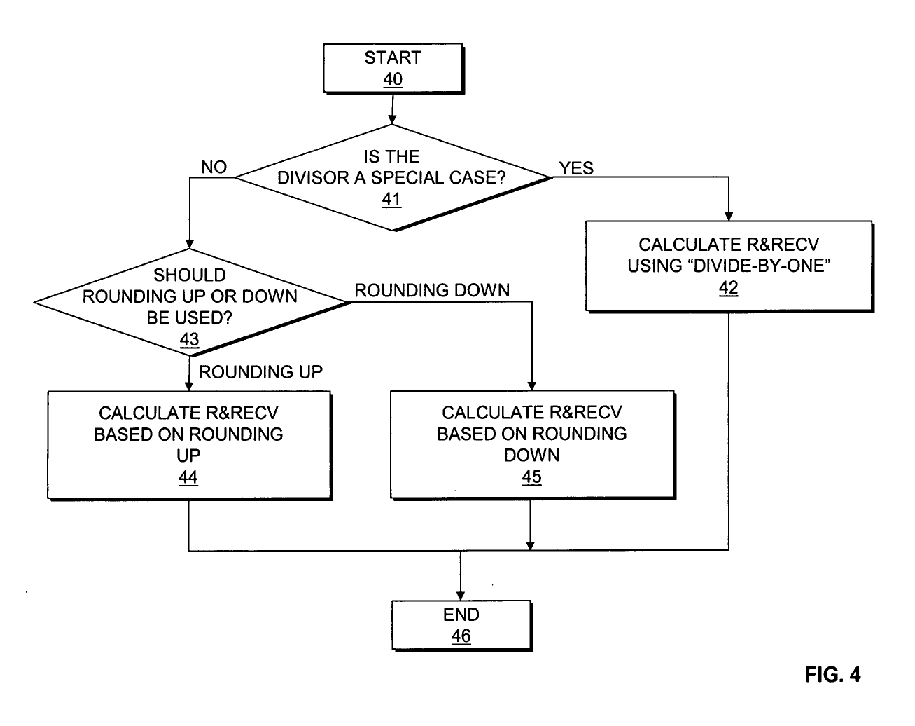

Before generating the multiply-add and shift-right instructions, the integer division system 10 employs the pre-calculation module 11 to select, determine, or calculate the reciprocal approximation a and the rounding error compensation value b. In accordance with an embodiment of the present invention, the pre-calculation module 11 determines whether the rounding-up or rounding-down should be used to select the reciprocal approximation a and/or the rounding error compensation value b. The pre-calculation module 11 either uses the integer arithmetic or floating-point arithmetic to make the determination. FIG. 4 shows the overall pre-calculation process of the pre-calculation module 11 in selecting or calculating the reciprocal approximation a and/or the rounding error compensation value b in accordance with an embodiment of the present invention, which will be described in more detail below.

As can be seen from FIG. 4, the pre-calculation process starts at block 40. At 41, it is determined whether the divisor d is a special case or not. Here, the term special case refers to instances in which the divisor d is of a specific value that for which rounding-up or rounding-down does not work. For example, it is a special case when the divisor d is equal to 1. In addition, the special case can also be set for those instances in which the determination of rounding-up or rounding-down of the reciprocal approximation is excessively complex (e.g., might require extra-precision arithmetic). For example, the special case can be set when the divisor d is a power of 2. In accordance with an embodiment of the present invention, the pre-calculation module 11 of FIG. 1 makes this special-case determination.

If, at 41, it is determined that the divisor d is a special case, it means that the reciprocal approximation a and the rounding error compensation value b will be determined without requiring the rounding-up or rounding-down determination. In this case, the process moves to block 42. If, however, the divisor d is determined not to be the special case, the process moves to block 43.

At 42, because the divisor d has been determined to be special, the reciprocal approximation a and the rounding error compensation value b (referred to in FIG. 4 as R&RECV) are calculated using the “divide-by-one” technique without going through the rounding-up or rounding-down determination. Here, the “divide-by-one” technique means that each of the reciprocal approximation a and the rounding error compensation value b is assigned to the value of 2^{N}−1. In accordance with an embodiment of the present invention, the pre-calculation module 11 of FIG. 1 makes this calculation. The process then ends at block 46.

At 43, it is determined whether the rounding-up or rounding-down should be used to calculate the reciprocal approximation a and the rounding error compensation value b. In accordance with an embodiment the present invention, the pre-calculation module 11 of FIG. 1 makes this determination. Depending on whether the integer division is signed or unsigned and depending on whether the integer arithmetic or floating-point arithmetic is used to calculate the reciprocal approximation a and the rounding error compensation value b, the precalculation module 11 of FIG. 1 employs different test formulas to make this determination.

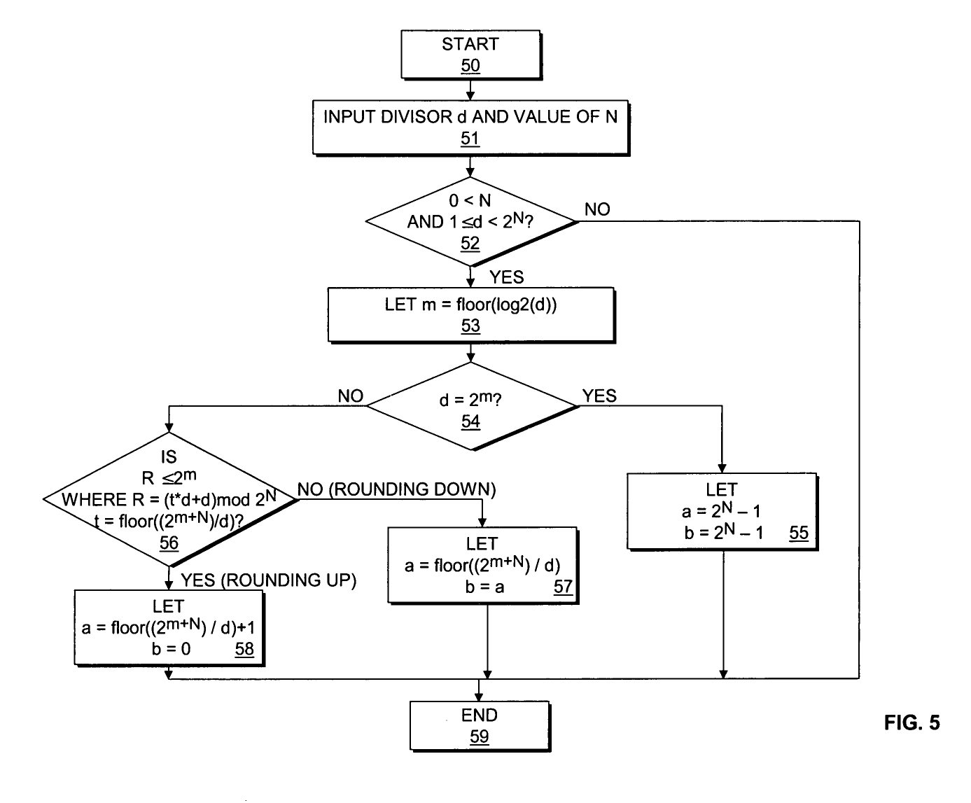

For example, if the integer division is an unsigned integer division and the integer arithmetic is used to calculate the reciprocal approximation a and the rounding error compensation value b, the pre-calculation module 11 of FIG. 1 employs the “(t*d+d) mod 2^{N}≦2^{m}” test for the determination, wherein t is a temporary quantifier which is calculated as (2^{m+N})/d. As a further example, if the integer division is a signed integer division over unsigned divisor and the integer arithmetic is used to calculate the reciprocal approximation a and the rounding error compensation value b, the pre-calculation module 11 of FIG. 1 employs the “(td+d) mod 2^{N}≦XMA.HU(d, t, 0)” test for the determination. Further, if the integer division is an unsigned integer division and the floating-point arithmetic is used to calculate the reciprocal approximation a and the rounding error compensation value b, the pre-calculation module 11 of FIG. 1 employs the “RND_{N}(−dt+1)≦0” test for the determination, wherein t=RND_{N}(1/d). If the integer division is a signed integer division and the floating-point arithmetic is used to calculate the reciprocal approximation a and the rounding error compensation value b, the pre-calculation module 11 of FIG. 1 does not employ any test for the determination. Instead, the pre-calculation module 11 skips this determination and simply lets m=(BIAS−1)−EXPONENT (t), a=SIGNIFICAND (t), and b=a/2. These will be described in more detail below, also in conjunction with FIGS. 5-8.

If, at 43, it is determined that the rounding-up should be used, the process moves to the block 44. If, at 43, it is determined that the rounding-down should be used, the process moves to block 45.

At 44, the precalculation module 11 of FIG. 1 calculates the reciprocal approximation a and the rounding error compensation value b (R&RECV) based on the rounding-up decision according to an embodiment of the present invention. Again, depending on whether the integer division is signed or unsigned and whether the integer arithmetic or floating-point arithmetic is used to calculate the a and the rounding error compensation value b, the pre-calculation module 11 of FIG. 1 selects or calculates the reciprocal approximation a and the rounding error compensation value b differently. This will be described in more detail below, also in conjunction with FIGS. 5-8. The process then ends at block 46.

At 45, the pre-calculation module 11 of FIG. 1 calculates the reciprocal approximation a and the rounding error compensation value b based on the rounding-down decision, in accordance with an embodiment of the present invention. Again, depending on whether the integer division is signed or unsigned and whether the integer arithmetic or floating-point arithmetic is used to calculate the a and the rounding error compensation value b, the pre-calculation module 11 of FIG. 1 selects or calculates the reciprocal approximation a and the rounding error compensation value b differently. This will be described in more detail below, also in conjunction with FIGS. 5-8. The process then ends at block 46.

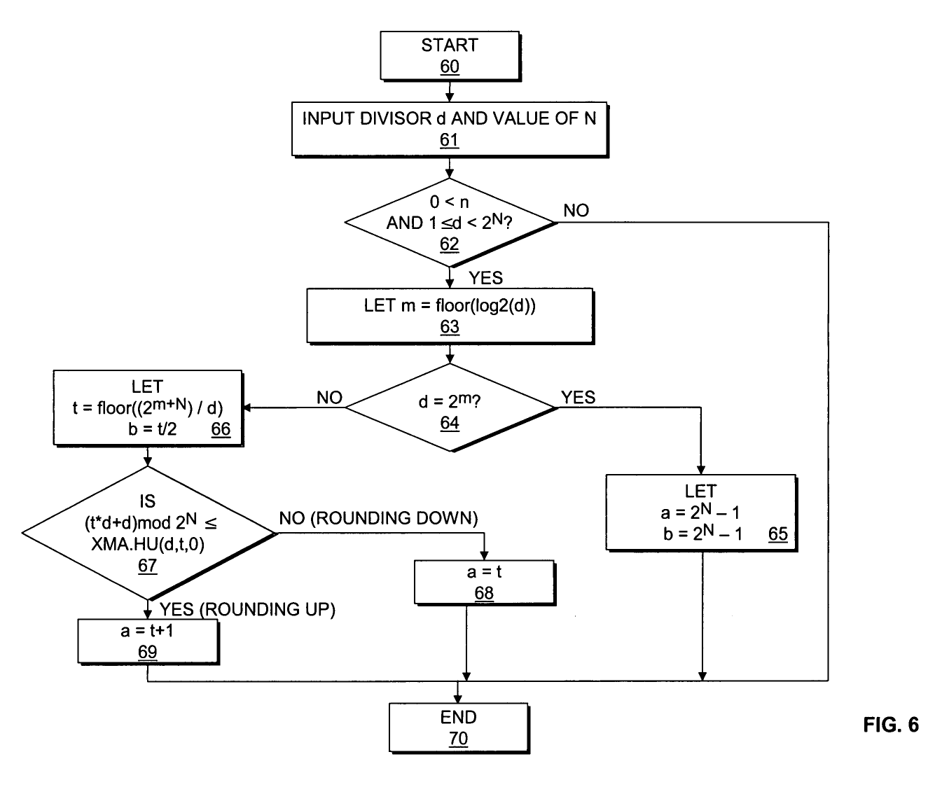

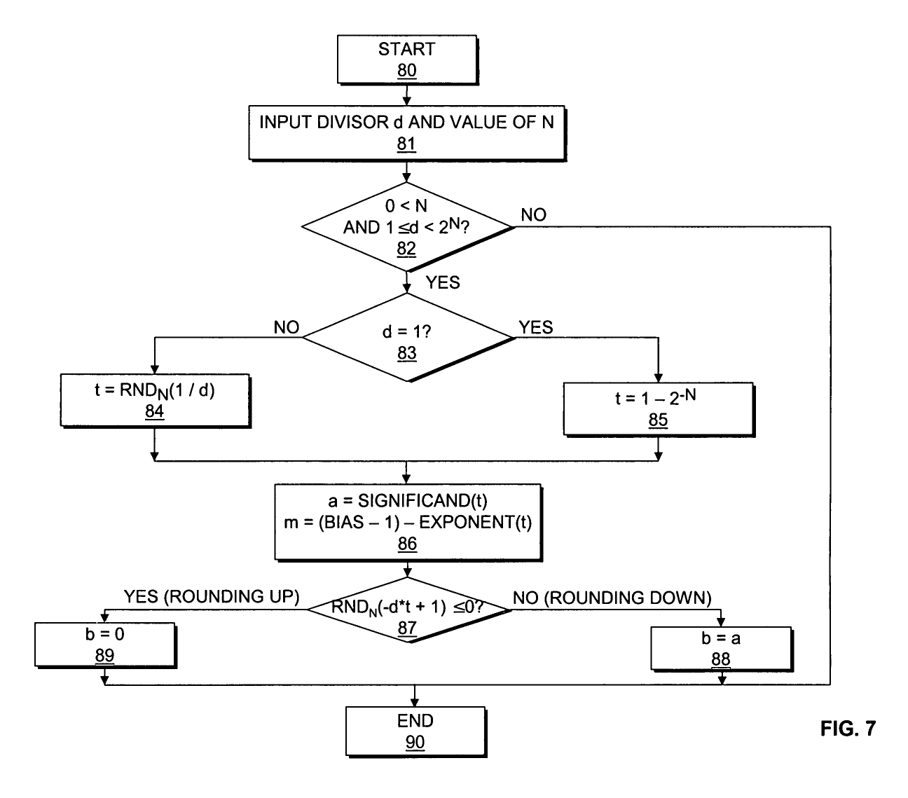

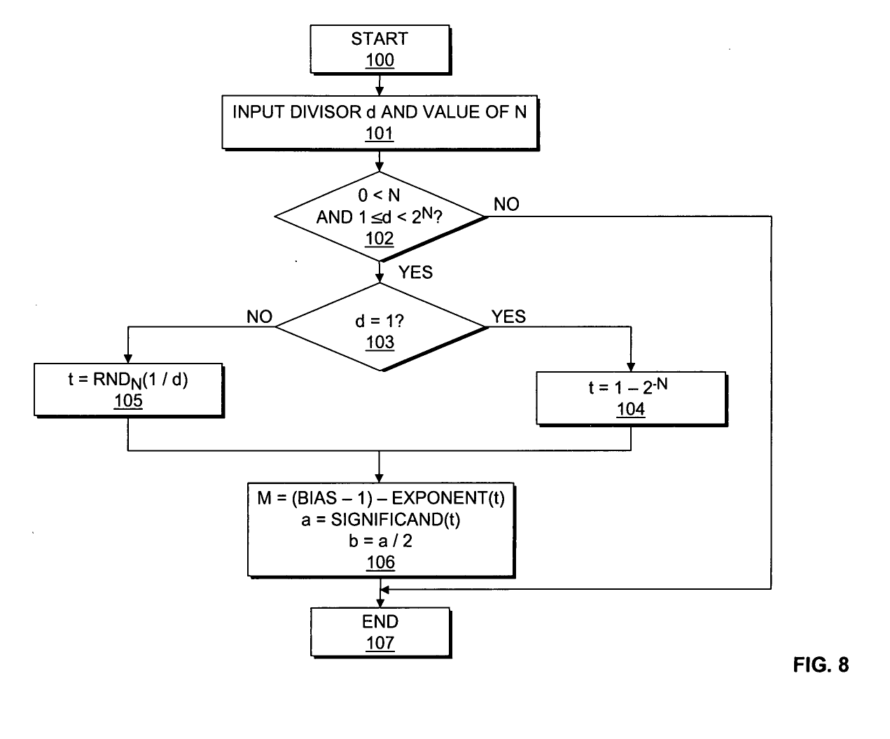

FIG. 5 shows the pre-calculation process of the pre-calculation module 11 of FIG. 1 for unsigned integer division using the integer arithmetic. FIG. 6 shows the pre-calculation process of the pre-calculation module 11 of FIG. 1 for signed integer division over unsigned divisor using the integer arithmetic. This means that in FIGS. 5-6, the pre-calculation module 11 of FIG. 1 uses an integer arithmetic unit of a processor to make the determination and calculation. FIG. 7 shows the pre-calculation process of the pre-calculation module 11 of FIG. 1 for unsigned integer division using the floating-point arithmetic. FIG. 8 shows the pre-calculation process of the pre-calculation module 11 of FIG. 1 for signed integer division over unsigned divisor using the floating-point arithmetic.

Referring to FIG. 5, the process starts at block 50. At 51, the divisor d and the value of N are inputted. According to an embodiment of the present invention, the pre-calculation module 11 (FIG. 1) performs this function. The value of N indicates the size of the divisor d represented in an N-bit processor.

At 52, it is determined whether N is greater than zero and the divisor d is greater than or equal to 1 but less than 2^{N}. In accordance with an embodiment of the present invention, the pre-calculation module 11 of FIG. 1 performs this function. If the determination is negative (i.e., NO), then the process ends at block 59. If the determination yields a positive response (i.e., YES), the process moves to block 53.

At 53, the value of m is calculated as floor(log₂(d)). In accordance with an embodiment of the present invention, the pre-calculation module 11 of FIG. 1 performs this calculation.

At 54, it is determined whether the divisor d is a special case (i.e., d=2^{m}). In accordance with an embodiment of the present invention, the pre-calculation module 11 of FIG. 1 performs this determination. If the divisor d is determined to be a special case at 54 (i.e., YES), then the process moves to block 55, at which the pre-determination module 11 lets each of the reciprocal approximation a and the rounding error compensation value b to have the value of 2^{N}−1. The process then ends at block 59.

If the divisor d is determined not to be a special case at 54 (i.e., NO), then the process moves to block 56, at which the pre-determination module 11 makes another determination in accordance with an embodiment of the present invention. This determination is to decide whether to round the reciprocal approximation a up or down to the nearest N-bits from the N+1 bits (and hence selecting the value of the rounding error compensation value b). The test used here for the determination is (td+d) mod 2^{N}≦2^{m}, wherein t is a temporary quantifier which is calculated as (2^{m+N})/d. The calculation must be done in double precision (2N bits), though the result always fits in a single word. This means that the calculation requires dividing a double word by a single word to compute t. Then the test “(td+d) mod 2^{N}≦2^{m}” is performed. The pre-calculation module 11 of FIG. 1 computes “(td+d) mod 2^{N}” using only N-bit unsigned arithmetic, as indicated by “mod 2^{N}”. On a 64-bit Intel Itanium processor (marketed by Intel Corporation of Santa Clara, Calif.), “(td+d) mod 2^{N} is simply XMA.LU(t, d, d).

If, at 56, the determination is to round down the reciprocal approximation a (i.e., NO), then the process moves to block 57. Otherwise, the process moves to block 58.

At 57, the reciprocal approximation a and the rounding error compensation value b are all let to be t (i.e., (2^{m+N})/d). In accordance with an embodiment of the present invention, the pre-calculation module 11 of FIG. 1 performs this function. The process then ends at block 59.

At 58, the reciprocal approximation a is let to be (t+1 ) while the rounding error compensation value b is set at zero (i.e., no error compensation). In accordance with an embodiment of the present invention, the pre-calculation module 11 of FIG. 1 performs this function. The process then ends at block 59. Below lists a code sequence that implements the process of FIG. 5.

Inputs: uword d and N, with N ≧1 and 1 ≦d < 2^{N}
int m: =floor(log₂(d));
uword a, b;
if d = 2^{m} then

a := 2^{N} − 1;
b := 2^{N} − 1;

else

uword t = floor((2^{N+m})/d);
uword r = (td + d) mod 2^{N};
if r ≦2^{m}

a := t + 1;
b := 0;

else

a := t;
b := t;

endif

endif
Emit SHR.U (XMA.HU (a, x, b), m)

Here, a variable of type “uword” is presumed to hold any N-bit unsigned value and a variable of type “int” is presumed to hold an integer. In addition, the instruction generation module 12 of FIG. 1 performs the last instruction in the code sequence shown above.

Referring to FIG. 6, the pre-calculation process of the integer division system 11 of FIG. 1 for signed integer division over unsigned divisor using integer arithmetic starts at block 60. At 61, the divisor d and the value of N are inputted. According to an embodiment of the present invention, the pre-calculation module 11 (FIG. 1) performs this function. The value of N indicates the size of the divisor d represented in an N-bit processor.

At 62, it is determined whether N is greater than zero and the divisor d is greater than or equal to 1 but less than 2^{N}. In accordance with an embodiment of the present invention, the pre-calculation module 11 of FIG. 1 performs this function. If the determination is negative (i.e., NO), then the process ends at block 70. If the determination yields a positive response (i.e., YES), the process moves to block 63.

At 63, the value of m is calculated as log₂(d), rounded down. In accordance with an embodiment of the present invention, the pre-calculation module 11 of FIG. 1 performs this calculation.

At 64, it is determined whether the divisor d is a special case (i.e., d=2^{m}). In accordance with an embodiment of the present invention, the pre-calculation module 11 of FIG. 1 performs this determination. If the divisor d is determined to be a special case at 64 (i.e., YES), then the process moves to block 65, at which the pre-determination module 11 lets each of the reciprocal approximation a and the rounding error compensation value b have the value of 2^{N}−1. The process then ends at block 70.

If the divisor d is determined not to be a special case at 64 (i.e., NO), then the process moves to block 66, at which the pre-determination module 11 lets t (a temporary quantifier) to be calculated as (2^{m+N})d in accordance with an embodiment of the present invention. In addition, the pre-calculation module 11 lets the rounding error compensation value b to be equal to t/2 (i.e., always error compensation).

At 67, it is determined whether to round the reciprocal approximation a up (i.e., towards positive infinity) or down (i.e., towards negative infinity) to the nearest N-bits from the N+1 bits. The test used here for the determination is (td+d) mod 2^{N}≦XMA.HU (d, t, 0). If the determination is to round up the reciprocal approximation a (i.e., YES), then the process moves to block 69. Otherwise, the process moves to block 68.

At 69, the reciprocal approximation a is set to be (t+1). In accordance with an embodiment of the present invention, the pre-calculation module 11 of FIG. 1 performs this function. The process then ends at block 70.

At 68, the reciprocal approximation a is set to be t. In accordance with an embodiment of the present invention, the pre-calculation module 11 of FIG. 1 performs this function. The process then ends at block 70. Below lists a code sequence that implements the process of FIG. 6.

Inputs: uword d and N, with N ≧1 and 1 ≦d < 2^{N}
int m: =floor(log₂(d));
uword a, b;
if d = 2^{m} then

a := 2^{N} − 1;
b := 2^{N} − 1;

else

uword t = floor((2^{N+m})/d);
b := t/2;
if (td + d) mod 2^{N} ≦XMA.HU (d, t, 0) then

a := t + 1;

else

a := t;

endif

endif
Emit SHR.U (x + XMA.HS (a, x, b), m)

Here, the instruction generation module 12 of FIG. 1 performs the last instruction in the code sequence shown above.

FIG. 7 shows the pre-calculation process of the pre-calculation module 11 of FIG. 1 for unsigned integer division using the floating-point arithmetic. This means that the calculation and determination is done using a floating-point unit of a processor. As can be seen from FIG. 7, the process starts at block 80. At 81, the divisor d and the value of N are inputted. According to an embodiment of the present invention, the pre-calculation module 11 (FIG. 1) performs this function.

At 82, it is determined whether N is greater than zero and the divisor d is greater than or equal to 1 but less than 2^{N}. In accordance with an embodiment of the present invention, the pre-calculation module 11 of FIG. 1 performs this function. If the determination is negative (i.e., NO), then the process ends at block 90. If the determination yields a positive response (i.e., YES), the process moves to block 83.

At 83, it is determined whether the divisor d is a special case. Here, the special case is defined to be d=1. In accordance with an embodiment of the present invention, the pre-calculation module 11 of FIG. 1 performs this determination. If the divisor d is determined not to be a special case at 83 (i.e., NO), then the process moves to block 84. If the divisor d is determined to be a special case at 83 (i.e., YES), then the process moves to block 85.

At 84, a temporary floating point value t is set to be RND_{N}(1/d), wherein RND_{N} (1/d) is accomplished using, for example, a sequence of Newton-Raphson iterations. This means that Newton-Raphson iterations are used to approximate 1/d, wherein the number of required iterations depends on the value of N.

The sequence of Newton-Raphson iterations should approximate 1/d, rounded to the nearest N-bits (unless d=2^{N}−1). If d=2^{N}−1, the sequence is allowed to deliver either the nearest N-bit approximation of 1/d, or 1/d rounded down to 2^{-N}. Such sequences, well known to practitioners of numerical arts, employ a reciprocal approximation instruction to initialize an initial estimate, and fused multiply-add operations to refine that estimate.

At 85, t is set to be 1−2^{-N}, which is the reciprocal of the divisor d nudged down by a unit of least precision. This has the effect of setting the significand of t to “all ones” and its unbiased exponent to −1. In accordance with an embodiment of the present invention, the pre-calculation module 11 of FIG. 1 performs this function.

At 86, m is set to be (BIAS−1)−EXPONENT (t). This means that m is set to be (−1) minus the unbiased exponent. In addition, the reciprocal approximation a is set to be SIGNIFICAND (t). In accordance with an embodiment of the present invention, the pre-calculation module 11 of FIG. 1 performs this function. After this, all that is left is to decide whether b should be zero or a. This is done at block 87.

At 87, it is determined whether b should be zero or a. In accordance with an embodiment of the present invention, the pre-calculation module 11 of FIG. 1 employs the test of “RND_{N}(−dt+1)≦0” to decide. This test actually determines whether the rounding error introduced by rounding an N-bit significand of a reciprocal approximation a to nearest is positive or negative. The error is of at most 2^{-N}. The test can be performed by a fused multiply-add operation. If the test is true (i.e., Rounding-up), then the process moves to the block 89. Otherwise, the process goes to block 88.

At 88, the rounding error compensation value b is set to be a. In accordance with an embodiment of the present invention, the pre-calculation module 11 of FIG. 1 performs this function. The process then ends at block 90.

At 89, the rounding error compensation value b is set to be zero (i.e., no error compensation). In accordance with an embodiment of the present invention, the pre-calculation module 11 of FIG. 1 performs this function. The process then ends at block 90. Below lists a code sequence that implements the process of FIG. 7.

Inputs: uword d and N, with N ≧1 and 1 ≦d < 2^{N}
uword a, b;
real t
if d = 1 then

t := 1 − 2^{-N};

else

t = RND_{N}(l/d);

endif
a: = SIGNIFICAND (t)
m:= (BIAS − 1) − EXPONENT(t)
if RND_{N}(−td + 1) ≦0 then

b := 0;

else

b := a;

endif
Emit SHR.U (XMA.HU (a, x, b), m)

Here, the instruction generation module 12 of FIG. 1 performs the last instruction in the code sequence shown above.

FIG. 8 shows the pre-calculation process of the pre-calculation module 11 of FIG. 1 for signed integer division over unsigned divisor using the floating-point arithmetic. This means that the calculation and determination is done using a floating-point unit of a processor. In addition and as can be seen from FIGS. 7-8, the blocks 100-105 in FIG. 8 perform the same functions as those blocks 80-85 in FIG. 7. Thus, those functional blocks 100-105 in FIG. 8 will not be described in more details below.

In FIG. 8, at 106, m is set to be (BIAS−1)−EXPONENT (t), a is set to be SIGNIFICAND (t), and b is set to be a/2. In accordance with an embodiment of the present invention, the pre-calculation module 11 of FIG. 1 performs this function. The process then ends at block 107. Below lists a code sequence that implements the process of FIG. 8.

Inputs: uword d and n, with N ≧1 and 1 ≦d < 2^{N}
uword a, b;
real t
if d = 1 then

t := 1 − 2^{-N};

else

t = RND^{N}(l/d);

endif
a: = SIGNIFICAND (t)
m:= (BIAS − 1) − EXPONENT(t)
b := a/2
Emit SHR.U (x + XMA.HS (a, x, b), m)

Here, the instruction generation module 12 of FIG. 1 performs the last instruction in the code sequence shown above.

FIGS. 4-8 are flow charts illustrating pre-calculation processes of the pre-calculation module 11 of FIG. 1 in calculating the reciprocal approximation a and the rounding error compensation value b according to embodiments of the present invention. Some of the procedures illustrated in the figures may be performed sequentially, in parallel or in an order other than that which is described. It should be appreciated that not all of the procedures described are required, that additional procedures may be added, and that some of the illustrated procedures may be substituted with other procedures.

In the foregoing specification, the embodiments of the present invention have been described with reference to specific exemplary embodiments thereof. It will, however, be evident that various modifications and changes may be made thereto without departing from the broader spirit and scope of the embodiments of the present invention. The specification and drawings are, accordingly, to be regarded in an illustrative rather than restrictive sense.

1. An integer division system for a dividend and a divisor, comprising:
a pre-calculation module to select a reciprocal approximation and a rounding error compensation value of the divisor, wherein the reciprocal approximation is of the same predetermined number of binary bits as the divisor and the pre-calculation module determines which one of rounding-up and rounding-down is used when selecting the reciprocal approximation and the rounding error compensation value;
an instruction generation module to generate an instruction to calculate a quotient of the dividend using the reciprocal approximation and the rounding error compensation value.

2. The system of claim 1, wherein the pre-calculation module selects the reciprocal and rounding error compensation value by calculating the reciprocal and the rounding error compensation value using an integer arithmetic unit of a processor.

3. The system of claim 1, wherein the pre-calculation module selects the reciprocal and rounding error compensation value by calculating the reciprocal and the rounding error compensation value using a floating-point arithmetic unit of a processor.

4. The system of claim 3, wherein for signed division over unsigned divisor, the rounding-up and rounding-down refer to rounding the reciprocal approximation towards positive and negative infinity respectively.

5. The system of claim 1, wherein the instruction generated by the instruction generation module includes a fused multiply-add instruction and a right-shift instruction.

6. The system of claim 1, wherein the pre-calculation module selects the reciprocal and rounding error compensation value by retrieving them from a lookup table in a cache of a processor.

7. The system of claim 1, wherein the pre-calculation module and the instruction generation module are located within a compiler.

8. The system of claim 1, wherein the pre-calculation module and the instruction generation module are located within a just-in-time compiler of a runtime environment.

9. The system of claim 1, wherein the pre-calculation module and the instruction generation module are located within, as a code sequence, a compiled code program.

10. A computer-implemented method of selecting a reciprocal approximation and a rounding error compensation value of a divisor in an integer division, comprising:
determining which one of rounding-up and rounding-down is to be used for selecting the reciprocal approximation and rounding error compensation value;
selecting the reciprocal approximation and the rounding error compensation value based on the determination, wherein the reciprocal approximation is of the same predetermined number of binary bits as the divisor.

11. The method of claim 10, wherein the determining and selecting are performed using an integer arithmetic unit of a processor.

12. The method of claim 10, wherein the determining and selecting are performed using a floating-point arithmetic unit of a processor, wherein for signed division over unsigned divisor, the rounding-up and rounding-down refer to rounding the reciprocal approximation towards positive and negative infinity respectively.

13. The method of claim 10, wherein the selecting is performed by retrieving the reciprocal approximation and the rounding error compensation value from a lookup table in a cache of a processor.

14. A method of performing an integer division, comprising
examining a divisor to determine which one of rounding-up and rounding-down should be used to select a reciprocal approximation and a rounding error compensation value of the divisor;
selecting the reciprocal approximation and the rounding error compensation value based on the examination, wherein the reciprocal approximation is of the same predetermined number of binary bits as the divisor;
generating at least an instruction to calculate a quotient of a dividend using the reciprocal approximation and the rounding error compensation value.

15. The method of claim 14, wherein the determining and selecting are performed using an integer arithmetic unit of a processor.

16. The method of claim 14, wherein the determining and selecting are performed using a floating-point arithmetic unit of a processor.

17. The method of claim 16, wherein for signed division over unsigned divisor, the rounding-up and rounding-down refer to rounding the reciprocal approximation towards positive and negative infinity respectively.

18. The method of claim 14, wherein the instruction generated includes a fused multiply-add instruction and a right-shift instruction.

19. The method of claim 14, wherein the selecting is performed by retrieving the reciprocal approximation and the rounding error compensation value from a lookup table in a cache of a processor.

20. An article of manufacture comprising a machine accessible medium including sequences of instructions, the sequences of instructions including instructions which, when executed, cause the machine to perform:
examining a divisor to determine which one of rounding-up and rounding-down should be used to select a reciprocal approximation and a rounding error compensation value of the divisor;
selecting the reciprocal approximation and the rounding error compensation value based on the examination, wherein the reciprocal approximation is of the same predetermined number of binary bits as the divisor;
generating at least an instruction to calculate a quotient of a dividend using the reciprocal approximation and the rounding error compensation value.

21. The article of manufacture of claim 20, wherein the determining and selecting are performed using an integer arithmetic unit of a processor.

22. The article of manufacture of claim 20, wherein the determining and selecting are performed using a floating-point arithmetic unit of a processor.

23. The article of manufacture of claim 22, wherein for signed division over unsigned divisor, the rounding-up and rounding-down refer to rounding the reciprocal approximation towards positive and negative infinity respectively.

24. The article of manufacture of claim 20, wherein the instruction generated includes a fused multiply-add instruction and a right-shift instruction.

25. The article of manufacture of claim 20, wherein the selecting is performed by retrieving the reciprocal approximation and the rounding error compensation value from a lookup table in a cache of a processor.
